(19) United States
(12) Patent Application Publication
(10) Pub. No.: US 2005/0220288 A1
(43) Pub. Date: Oct. 6, 2005

(54) Technique for routing a call to a call center based on the geographic origin of the call

(76) Inventor: Christopher A. Huey, Banks, OR (US)

Correspondence Address: KAYE SCHOLER LLP, 425 PARK AVENUE, NEW YORK, NY, 10022-3598, US

(21) Appl. No.: 10/813,974

(22) Filed: Mar. 31, 2004

(51) Int. Cl. H04M 3/00; H04M 5/00; H04M 7/00

(52) U.S. Cl. 379/265.02; 379/221.01

(57) ABSTRACT

A telephone or other communications device may be identified by a telephone number based on a home area (e.g., “NPA” or area code). When a caller is traveling with a cellular telephone, for example, the caller may call an information assistance service to provide information about the place being visited. Based on the location of the originating switch, the call may be routed to the call center closest to the caller. Sometimes, the call is first routed to a call center closest to the phone's home area. In this case, the call center receives from the signaling stream associated with the call a caller location identifier or an originating switch identifier, which identifies the caller's location or vicinity. If another call center is closer to the caller than the first call center, the first call center reroutes the call to that closer call center. The invention allows an information assistance call to be routed to a call center closest to a caller's location rather than to the call center closest to the home area. This may be advantageous when a caller is traveling and wants to have an operator local to the caller's location handle the call.

### BACKGROUND OF THE INVENTION

The invention relates generally to an information assistance system and method. More specifically, the invention relates to a system and method for routing a call to a call center providing information assistance service.

In a typical directory assistance call, a caller identifies to an operator the name and address (sometimes city or area code) of a party whose telephone number is desired. In response, the operator locates the desired destination telephone number using, e.g., a computer database. The destination number is then provided to the caller, e.g., by a voice server which provides automated voicing of the number, and the caller is afforded an option to be connected to the destination number without the need of first terminating the directory assistance call.

Information assistance is an extension of directory assistance. In addition to connecting a caller to a destination number, information assistance operators can provide concierge-type services such as a restaurant guide and reservation service, event ticketing and reservation service, hotel reservation and availability service, travel or flight reservation and ticketing services, ordering specific items such as flowers or food delivery, arranging transportation, and accessing entertainment guides. The use of information assistance to provide such concierge-type services is disclosed, e.g., in commonly-assigned, co-pending U.S. application Ser. No. 09/520,306, “Technique for Providing Information Assistance Including Concierge-Type Services,” filed Mar. 7, 2000, incorporated herein by reference.

Telephone systems use a variety of signaling protocols to establish telephone calls across telephone lines owned by different entities. One of these protocols, Feature Group D (FG-D), defines interconnection rules between a local exchange carrier (LEC) and an inter-exchange carrier (IEC or long-distance carrier). FG-D services route inter-LATA calls to the IEC point of termination, route calls with a carrier access code to the user's carrier, and pass information to the carrier. Information passed includes an automatic number identification (ANI), identifying the caller's telephone number.

Unlike FG-D, more advanced signaling systems have a signaling channel separate from a group of voice channels associated therewith. This “out-of-band” signaling channel may transmit a multitude of information for each voice channel that was not transmitted using FG-D, such as the identity of the switch from which a call originates (“originating switch identifier”). One such advanced signaling system is “SS7” (Signaling System 7), which may also be referred to as “C7,” “Common Channel Signaling System No. 7,” or “CCSS7.” SS7 is a global standard for telecommunications defined by the International Telecommunication Union. The standard defines the procedures and protocol by which network elements in the public switched telephone network (PSTN) exchange information over a digital signaling network to effect wireless (cellular) and wireline call setup, routing, and control. Similarly, for calls using VoIP (voice over IP (Internet Protocol)), a session initiation protocol (SIP) may be used to establish and terminate a VoIP call session. The SIP also has the ability to pass both a call identifier and an originating switch identifier. For details on SIP, one may refer, e.g., to Radvision Ltd.'s “SIP: Protocol Overview” (2001), at http://www.radvision.com.

### SUMMARY OF THE INVENTION

Using a protocol that passes a caller location identifier or an originating switch identifier (also known as an initiating switch locator) through the telecommunications network allows for improvements over the prior art information assistance service, and allows a call to be routed to an information/call center based on the geographic location of the calling (or communications) device. In particular, the invention involves receiving a call at a first call center, which is routed to that call center based on a communications device identifier, such as ANI. The geographic vicinity of the communications device is then determined, and the call is routed to a second call center if that second call center is closer to the geographic vicinity of the communications device than the first call center.

In another aspect of the invention, a signaling stream associated with the call is received. This signaling stream includes at least a caller location identifier or an initiating switch locator for identifying, respectively, the geographic vicinity of the caller or the switch through which the call is initially being routed. The geographic vicinity of the communications device is then determined by decoding the caller location identifier or the initiating switch locator. The caller location identifier may be a “caller geodetic location information parameter” (CGLIP). The initiating switch locator may be a “jurisdiction information parameter” (JIP), a “call reference parameter” (CRP), or a “CLLI” (Common Language® Location Identification) code. Once the parameter is received, the information is decoded to determine the location of the caller or of the initiating switch. The signaling stream may be formatted in accordance with the SS7protocol. In another aspect of the invention, the call content is formatted according to a VoIP protocol and the signaling stream is formatted according to SIP or H.323.

Further aspects include routing the call to a second call center if the second call center is the closest to the caller, or in or near the same state, LATA (local access and transport area), or time zone as that of the caller or communications device. In addition, the call may be routed to a third call center based upon the expected wait time at the second call center.

A system according to the invention is provided. This system includes an interface for receiving at a first call center a signaling stream associated with the call, the signaling stream including at least a communications device identifier and a caller location identifier or an initiating switch locator. The caller location identifier identifies the geographic vicinity of the caller, and the initiating switch locator identifies the geographic vicinity of the switch through which the call is initially being routed. The system also includes a database for relating the caller location identifier or initiating switch locator to the geographic vicinity of the caller or initiating switch, respectively. The system also includes a processor for retrieving the geographic vicinity of the caller or initiating switch, for determining a second call center closer to the geographic vicinity of the caller location or initiating switch location, and for routing the call to that second call center.

Advantageously, the invention allows an information assistance call center that is geographically closer to a caller handle an information assistance call so that the call may be handled by operators at the closer call center who may have more local knowledge.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 illustrates a communications system including information/call centers in accordance with an embodiment of the invention;

FIG. 2 illustrates an arrangement including a caller terminal, an originating switch, and two information/call centers in accordance with an embodiment of the invention;

FIG. 3 illustrates an information assistance service provider and a servicing platform for providing an information assistance service;

FIG. 4 illustrates an SS7 signaling network;

FIG. 5A illustrates an ISUP message template containing fields used to signal a telephone call in accordance with an embodiment of the invention;

FIG. 5B is an example of an ISUP message containing caller or originating switch location information in accordance with an embodiment of the invention; and

FIG. 6 is a table showing how a response to an 800-query message may be made;

FIG. 7 is an example of two ISUP messages used to determine different originating switch location information in accordance with an embodiment of the invention;

FIG. 8 illustrates a routine for routing a call based on geographic origin in accordance with an embodiment of the invention;

FIG. 9 illustrates a variation of the arrangement in FIG. 2 for use with a VoIP network in accordance with another embodiment of the invention; and

FIG. 10 illustrates a further variation of the arrangement in FIG. 2 in accordance with another embodiment of the invention.

### DETAILED DESCRIPTION

The present invention is directed to routing an information assistance call to a call center geographically proximate to the caller. In some instances, the call may have been originally routed to a call center based upon a caller's telephone number. In one example of the invention, the caller has a wireless telephone number (503) 555-2342, in which area code 503 is in Oregon. When the caller is traveling, e.g., in Washington, D.C., and calls information assistance, the ANI in the call signals associated with the wireless telephone identifies, although wrongly, that the call originates from Oregon and the call is routed to a call center located on the West Coast (i.e., close to Oregon). However, it may be more advantageous for the caller to receive information assistance from a call center that is geographically closer to Washington, D.C., where the caller is currently located. Thus, in one aspect of the invention, along with the ANI, the signaling stream of the call includes information identifying the caller's location or originating switch location (alternatively called “initiating switch location”) as being in or near Washington, D.C. When the call is placed, the ANI causes the call to be routed to the call center that is closest to the caller's home area, e.g., the West Coast call center, as in the prior art. However, in accordance with the invention, the West Coast call center then determines, based on the information identifying the caller's location or the originating switch location, that the call originates in or near Washington, D.C., and that the Washington, D.C. call center, whose operators may have better local knowledge, is a better call center from which to service the call, and transfers the call to the Washington, D.C. call center.

The caller's “home area” is that region identified by the first three digits of a caller's ANI, which is usually denoted by “NPA.” In the North American Numbering Plan (“NANP”), a number has 10 digits—NPA-NXX-XXXX—where “NPA” stands for “Numbering Plan Area” and is typically an area code; “NXX” is a telephone exchange; and “XXXX” stands for any four digits, and is the line number. Routing a call based on the originating ANI NPA is called “NPA Routing.”

The invention is premised upon the recognition that certain call set-up signals, e.g., in accordance with the SS7 protocol, may contain a caller location identifier or an originating switch identifier. An information assistance call is typically switched to a call center based upon the ANI; then, in accordance with the invention, that call center reads the caller location identifier or the originating switch identifier and reroutes the call to the call center that is closest to the caller or originating switch location (and thus to the caller). The invention involves reading the caller location identifier or the originating switch identifier, determining the location of the caller or the originating switch, determining the call center closest to the caller or originating switch, and transferring the call to that closest call center. The information assistance service environment is illustratively described below.

An expansive network of information/call centers may be used from which operators can effectively provide users with information and communications services. Such services may include, e.g., providing directory information, movie listings, restaurant recommendations, driving directions to various places, etc.; making reservations; sending invitations; administering appointment calendars; ticketing; and conducting other transactions for the users. The term “operator” used herein broadly encompasses entities that are capable of providing information assistance in a telecommunications environment, including, without limitation, human operators, voice response/recognition capabilities, web-/WAP-enabled operator services, and other automated and electronic access.

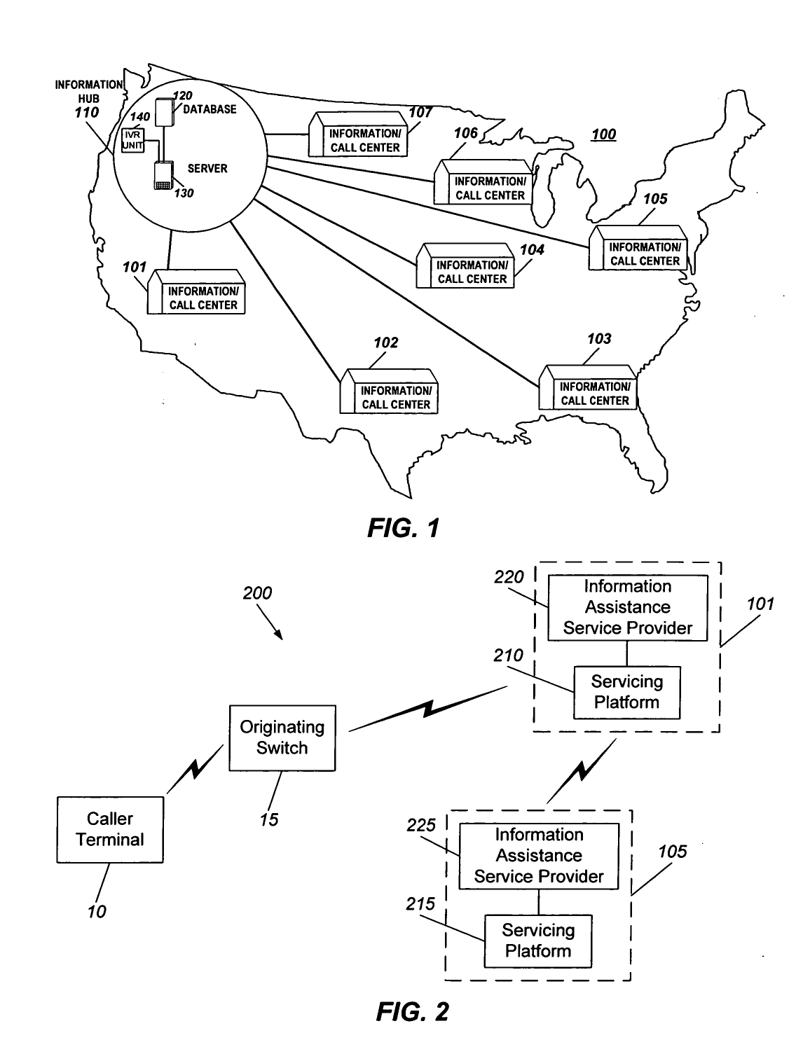

FIG. 1 illustrates a system embodying aspects of the invention, which includes wide area network (WAN) 100 covering an extensive area. WAN 100 can be an intranet-based network or an Internet-based network such as the World Wide Web. In this illustrative embodiment, WAN 100 connects operators dispersed throughout a wide coverage area in information/call centers 101-107. Each of information/call centers 101-107 covers one or more regional coverage areas. One or more information hubs 110 are also included in WAN 100. An information hub 110 includes one or more servers 130 which are accessible by the operators in the system and one or more databases 120 in which users' contacts, appointments, and other folders and information are stored and maintained. Information hub 110 may also include interactive voice response (IVR) unit 140 connected to server 130 for interacting with the user by voice, e.g., announcing to the user selected appointments. In addition to storing folders and information in information hub 110, they may also be stored locally at one or more of the information/call centers. The folders and information at different centers are synchronized. Synchronized databases provide necessary backup as well as support to roaming mobile device users.

In operation, a user dials a designated access number, e.g., “411,” “*555,” “#555,” “555-1212,” “00,” etc., and the call is routed to, say, information/call center 101 where an operator attends to the call. As described above, the user may be identified by ANI or, alternatively, by, or in combination with, a user ID, password, PIN, mother's maiden name, user voice recognition, user voiceprint, etc. In the case in which the user desires an information assistance service, such as a directory assistance, information management, or concierge-type service, the user makes such a request to the operator and the operator accesses server 130 through WAN 100 (or alternatively via the Internet).

FIG. 2 illustrates system 200 in which a caller initiates an information assistance call from caller terminal 10, which is routed to, say, information/call center 101 via one or more carrier switches in a carrier network, e.g., the PSTN, a wireless telephone network, etc. Originating switch 15 is the first of these carrier switches encountered by a call from caller terminal 10. In practice, for a wireline call, the originating switch is the switch within the caller's local phone company's “central office” (“CO”) to which the caller's telephone line is connected. It is often identified by “NXX” or the caller's exchange. (In countries outside the U.S., the CO may be called a “public exchange.”) For a wireless call, the originating switch is the switch within the caller's wireless carrier's “mobile telephone switching office” (“MTSO”), which handles the call after being routed from the caller's phone via one or more cellular towers.

In a conventional manner, the call is routed to information/call center 101 because that is the call center that is geographically closest to the location (i.e., area code or LATA) represented by the caller's ANI. Caller terminal 10 may comprise a wireless telephone, wireline telephone, personal digital assistant (PDA), computer, or other communications device. System 200 also includes information call/center 105, which is the call center that is geographically closest to the caller at the time of the call. In accordance with the invention, when the caller's geographic location differs from the location represented by the communications device's ANI, such as when the caller is traveling and using a wireless telephone whose NPA corresponds to the caller's home area, the call is forwarded from information/call center 101 to information/call center 105 to better serve the caller. In this illustrative embodiment, users may dial, speak or otherwise communicate predetermined access digits, access codes or retail numbers, or input a predetermined address or URL (uniform resource locator) established by the carrier to access information/call center 101. In the example described above, the predetermined access digits may be “411,” “*555,” “#555,” “555-1212,” “00,” etc. Once connected to information/call center 105, the user requests information assistance.

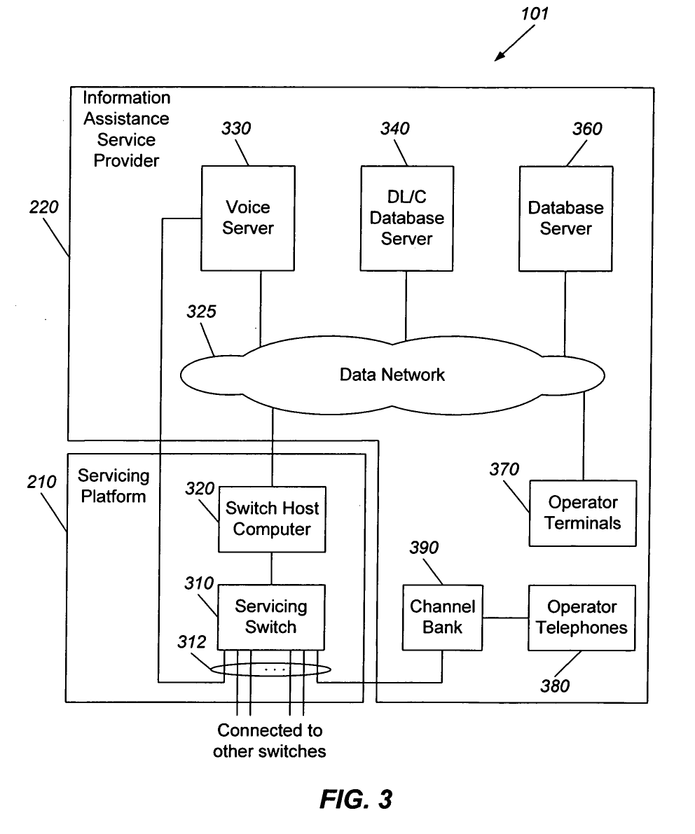

FIG. 3 illustrates information/call center 101, which may be configured to include information assistance service provider 220 together with servicing platform 210. It should be noted that even though both provider 220 and servicing platform 210 appear in the same figure, they may or may not be located in the same geographic area (and may or may not be controlled by the same entity). Information/call center 105 (as well as the other information/call centers 102-104, 106-107) is configured similarly, having information assistance service provider 225 and servicing platform 215. Service provider 225 and servicing platform 215 operate similarly to service provider 220 and servicing platform 210, as will now be described.

Servicing platform 210 includes servicing switch 310 having T1 spans 312 or connections by other means for connection to one or more voice servers 330 (although only one is shown in the figure), channel bank 390, and one or more carrier networks. In an alternate embodiment, voice information may be packetized and transmitted pursuant to a VoIP protocol over a packet-switched network, e.g., the Internet, to information/call center 101. Servicing switch 310 may receive an incoming information assistance call from a carrier switch in a carrier network. Servicing switch 310 may also be used to place an outgoing call onto a carrier network, which may be different from the carrier network used for the incoming call.

Channel bank 390 in service provider 220 is used to couple multiple operator telephones 380 to servicing switch 310. The operators in information/call center 101 are further equipped with operator terminals 370, each of which includes a video display unit and a keyboard with an associated dialing pad. Operator terminals 370 are connected over data network 325 to one or more database servers 360 (although only one is shown in the figure). Operators may use database server 360 to provide information assistance including searching various databases in a manner described below to satisfy a caller's request. Other information assistance concerning restaurant recommendations, movie listings, events, etc. may also be provided by searching one or more internal and external databases, and the Internet. Switch host computer 320 and voice server 330 are also connected to data network 325. By way of example, data network 325 includes a local area network (LAN) supplemented by a number of point-to-point data links. Through data network 325 and routers (not shown), components of information/call center 101 may also be connected to the Internet or other wide area networks (WANs).

Servicing switch 310 is conventional and supports digital T1 or perhaps other connectivity. The operation of servicing switch 310 is governed by instructions stored in switch host computer 320. In this illustrative embodiment, servicing switch 310 includes, among other things, arrays of digital signal processors (DSPs). These DSPs can be programmed and reprogrammed to function as, among other things, call progress analyzers (CPAs), multi-frequency (MF) tone generators/detectors, voice recognizers, dual-tone multi-frequency (DTMF) generators/detectors, or conference units, depending on the demand placed on information/call center 101 and servicing switch 310 for each corresponding function.

An incoming call requesting information assistance is received by servicing switch 310 in information/call center 101, which connects it to an available operator's telephone. If no operator is available when a call is received, the call is queued in a conventional manner until an operator becomes available. In this instance, automatic call distribution (ACD) logic of conventional design (not shown) is used to queue and distribute calls to operators in the order in which they are received, and such that the call traffic is distributed evenly among the operators. The ACD logic may reside in host computer 320 or elsewhere in information/call center 101. In other instances, other distribution logic schemes may be utilized, such as skills-based routing or a priority scheme for preferred users. In an illustrative embodiment, the signaling associated with an information assistance call for establishing the call is “out-of-band” in accordance with the SS7 protocol. When the call signaling is received by servicing switch 310 in information/call center 101, switch 310 derives, in a well-known manner, from the call signaling the caller's phone number from which the call originates (ANI) and a parameter used to identify the caller's location or the originating switch location.

Voice server 330 (also known as a “voice response unit” or “VRU”) is used to play the constant repeated parts of an operator's speech, namely, the various greetings and signoffs (or closings) as well as other information portions of a call. Voice server 330 is connected via data network 325 to switch host computer 320 and via one or more T1 spans 312 to servicing switch 310. Voice server 330 may comprise a general-purpose computer and one or more voice cards for voice recognition, voice recording and playback, DTMF detection, and call progress analysis. At appropriate stages in a call progression, switch host computer 320 initiates a voice path connection between voice server 330 and servicing switch 310 such that the user, or the user and the operator, are able to hear whatever pre-recorded speech is played on that connection by voice server 330. Computer 320 then instructs voice server 330, via data network 325, what type of message to play, and passes data parameters that enable voice server 330 to locate the message appropriate to the call state.

Data network 325 may further connect to directory listing/concierge (DL/C) database server 340. DL/C database server 340 may contain directory listing information on restaurants, events, accommodations, transportation, travel information and booking, stock prices, weather, and other services such as grocery or flower delivery, etc. Together, DL/C database server 340 and database server 360 provide operators with the means to search for a caller's desired party and determine the appropriate telephone number. Preferably, these databases can search not only by name and address, but also by type of goods/services and/or geographical region, or by any other attribute in the caller record, including phone number. For example, DL/C database server 340 can answer queries soliciting the names/numbers of restaurants serving a desired cuisine on a given street.

More particularly describing an illustrative embodiment of the invention, the caller is traveling and calls information assistance to find out about a service provider near to the caller's location. This may occur, for instance, if the caller needs assistance with concierge-type services to make restaurant or hotel reservations, to order specific items such as flowers or food delivery, to access entertainment guides, or to find the location of nearby service providers. Such assistance may be better provided by operators who are more proximate to the caller's immediate location and may have a more specialized knowledge of the local area. However, in the conventional information service arrangement, the call is routed to the information/call center that is geographically closest to the caller's home area (e.g., Oregon or area code 503), which is based on the area code of the caller's wireless telephone number, and that call center handles the call. With the invention, the call handled by a call center that is closer to the caller's physical location (e.g., Washington, D.C.) than a call center near the caller's home area.

One way to reroute this information assistance call is to derive the caller's location from the signaling associated with the call. With advanced signaling systems such as, SS7 and VoIP, the signaling stream includes information that can be converted to the location of the caller or the vicinity (e.g., city and state) of the switch that originates the call. Then, the closest information/call center to that switch location is determined, and the call can be rerouted to that information/call center.

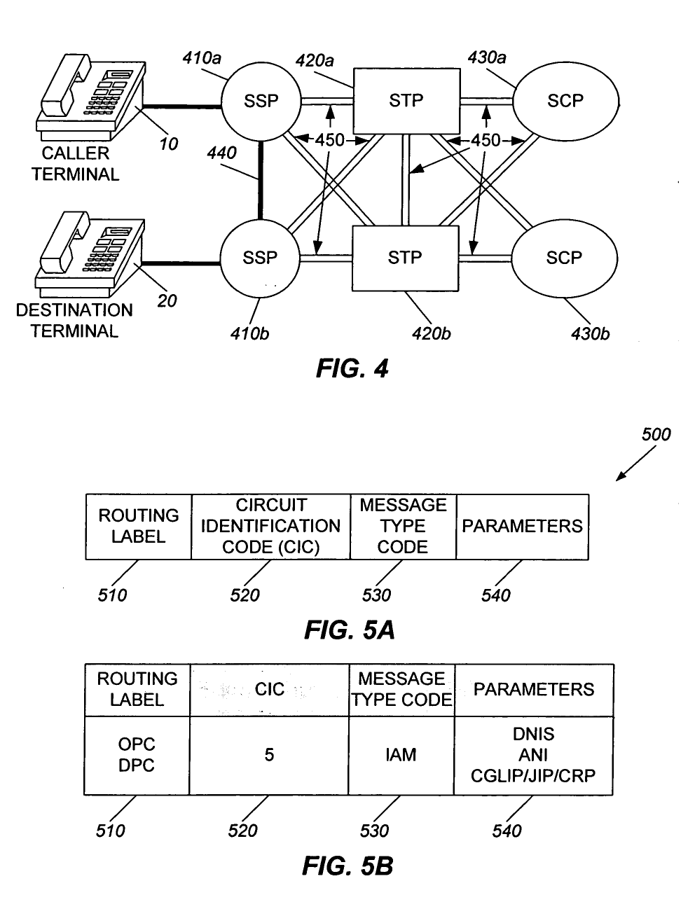

Referring to FIG. 4, SS7 systems use signaling points between which a call between caller terminal 10 and destination terminal 20 is conducted. These signaling points can be “SSPs” (service (or signal) switching points) 410, “STPs” (signal transfer points) 420, and “SCPs” (service (or signal) control points) 430. Each of these points (or nodes) in an SS7 network has a “point code” that uniquely identifies it. Point codes are used to direct signaling messages to the appropriate destinations. Voice trunks 440 carry the telephone call between originating switch 410a and destination switch 410b, while SS7 links 450 carry the out-of-band signals.

SSPs 410 (originating switch or SSP 410a and destination switch or SSP 410b) are telephone switches that perform call processing on calls that originate, terminate, or tandem at that point. SSPs 410 generate SS7 messages to transfer call-related information to other SSPs 410 or to query SCPs 430 for routing instructions. The response to such a query may determine how to route a call (e.g., a toll-free 1-800/888 call in North America). SCP 430 sends a response to originating SSP 410a containing the routing number(s) associated with the dialed number. An alternate routing number may be used by SSP 410 if the primary number is busy or the call is unanswered within a specified time. Actual call features vary from network to network and from service to service.

SCPs 430 contain centralized network databases for providing enhanced services. SCPs 430 accepts queries from SSPs 410 and return the requested information to the requestor.

STPs 420 are switches that relay messages between network switches (e.g., SSPs 410) and databases (e.g., SCPs 430). Their main function is to route SS7 messages to the correct outgoing signaling link, based on SS7 message address fields.

SS7 systems use “ISUP” messages to transmit information in the out-of-band channel. “ISUP” stands for ISDN (Integrated Services Digital Network) User Part, and an ISUP message is one of several protocols used by an SS7 telephone call or session. ISUP defines the protocol and procedures used to set up, manage, and release trunk circuits that carry voice and data calls over the public switched telephone network (PSTN). (Although “ISDN” is part of the acronym “ISUP,” an ISUP message is used for both ISDN and non-ISDN calls.) As shown in FIG. 5A, an ISUP message 500 includes routing label 510, circuit identification code (CIC) 520, and message type code 530, and parameters 540. Routing label 510 is a label contained in a signaling message and used to identify particulars to which the message refers. It contains the originating point code and destination point code so as to route the message towards its destination point. CIC 520 indicates the trunk circuit reserved by the originating switch to carry the call. A CIC of “5” denotes trunk circuit 5 out of, for example, 24 trunk circuits. Message type code 530 defines the contents of the remainder of the message. There are more than 30 message types, among which are “IAM” (“Initial Address Message”), “ACM” (“Address Complete Message”), “ANM” (“Answer Message”), “REL” (“Release”), and “RLC” (“Release Complete”). Other message types include “CPG” (“Call progress”), “CVT” (“Circuit Validation Test”), “CVR” (“Circuit Validation Response”), “CON” (“Connect”), and “SUS” (“Suspend”). Message type code 530 may also call for some parameters 540, which make up the rest of the ISUP message.

In a typical SS7 call, originating switch 410a sends an ISUP initial address message (IAM) to reserve an available trunk circuit (e.g., trunk 5) between originating switch 410a and destination switch 410b. The ISUP IAM, shown in FIG. 5B, includes the originating and destination point codes (and other information) as part of routing label 510, a value of 5 for CIC 520, message type “IAM” in message type code 530, and parameters 540. In the ISUP message shown in FIG. 5B, parameters 540 include “DNIS” (“dialed number identification service”), the destination number dialed by the caller, “ANI,” the caller's telephone number, and a parameter indicating the geographical location of the caller or the vicinity of the originating switch (the ANI and the location parameter may be optional). The choices shown in FIG. 5B are “CGLIP” (“caller geodetic location information parameter”), “JIP” (“jurisdiction (or jurisdictional) information parameter”), and “CRP” (“call reference parameter”). The “CRP” may also be known as “CRF” (call reference).

The IAM is routed via STP 420a to destination SSP 410b. Destination switch 410b examines the DNIS and determines, by checking its routing table, whether SSP 410b serves destination terminal 20 and that the line is available for ringing. SSP 410b rings destination terminal 20 and returns an ISUP. ACM (address complete message) via STP 420b to originating SSP 410a indicating that the trunk circuit has been reserved. Originating SSP 410a rings caller terminal 10 and connects the caller's line to the trunk circuit. (Note that FIG. 4 shows originating and destination SSPs 410 directly connected with trunks, but it is possible that either or both SSPs 410 is not connected directly with the trunks, in which case trunk circuits are reserved via intermediate switches (not shown).)

Once the destination terminal 20 answers, destination SSP 410b sends an ISUP “ANM” (answer message) to originating SSP 410a via STP 420b. Originating SSP 410a verifies that caller terminal 10 is connected and initiates billing. The switch connected to the terminal that hangs up first (e.g., originating switch 410a if the caller hangs up first) sends an ISUP “REL” (release) message to release the trunk circuit. The other switch (e.g., destination switch 410b) disconnects the trunk and sends an ISUP “RLC” (release complete) message to the originating switch, which terminates the billing for that call and frees up the trunk circuit.

In the illustrative example of the present invention used herein, a caller having a telephone with an Oregon number is traveling in Washington, D.C., and dials an information assistance service. To make it easy for the caller, this information assistance service can be reached from anywhere in the country (or continent, possibly) by dialing a single national number, e.g., 800-type toll-free or 900-type toll call. Typically, such numbers can be considered “virtual” telephone numbers in that they are used to point to real telephone numbers but are not assigned to a subscriber line itself.

Referring to FIGS. 2, 4, 5A, and 5B, caller terminal 10 is located in Washington, D.C., and information/call center 101 replaces destination terminal 20 in FIG. 4. Dialing of a national number signals to originating switch 410a to suspend the call and query database SCP 430 for further instructions. Thus, originating switch 410a sends an “800-query message” via STP 420a to SCP 430a. This message contains at least the dialed national number (DNIS) and the caller's number (ANI). SCP 430a extracts the DNIS and ANI from the query message and, from its stored records, returns the number of the call center geographically closest to the region indicated by the ANI.

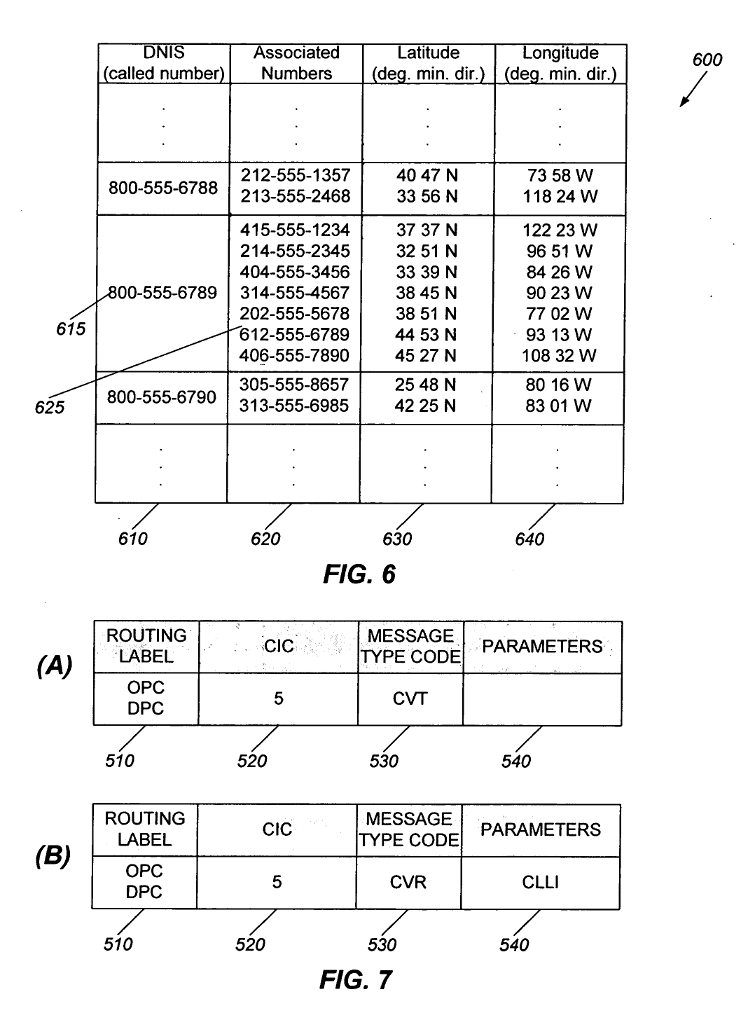

This scenario is illustrated in FIG. 6, which shows a table 600, that can be used to determine the response to the 800-query message. Table 600 includes at least four types of data in four columns: column 610 is for DNIS; column 620 is for telephone numbers associated with that DNIS (i.e., to which a call to the DNIS could be routed to); and columns 630 and 640 respectively list the latitude and longitude associated with the telephone number in column 620. Assume the number called (DNIS) is 800-555-6789, and the ANI starts with 503 (area code for Oregon). SCP 430 receives the DNIS and ANI, and compares the DNIS to the first column 610 of table 600. This column includes all possible 800-type (e.g., 866, 877, 888, 900) numbers. When SCP 430 finds the DNIS (e.g., after 800-555-6788, but before 800-555-6790), it examines column 620 for the associated telephone numbers. In this case, there are seven numbers relating to information/call centers 101-107 all over the country. (Specifically, FIG. 6 shows center 101 in San Francisco, Calif.; center 102 in Dallas, Tex.; center 103 in Atlanta, Ga.; center 104 in St. Louis, Mo.; center 105 in Wash., D.C., center 106 in St. Paul, Minn.; and center 107 in Billings, Mont.) For each center, table 600 supplies the latitude and longitude of each specific call center. From this information, SCP 430 can calculate the distance between each call center and the location represented by the ANI (which may not have to be any more specific than just the area code within the ANI). SCP 430 then returns the telephone number of the call center having the shortest distance. Thus, a call from a telephone with a 503 area code will most likely be directed to the San Francisco, Calif., call center, center 101.

Originating switch 410a then dials that call center (as destination terminal 20), initiating an SS7 call with an IAM as described above and shown in FIG. 5B. One of the three parameters identifying the caller (CGLIP) or originating switch location (JIP or CRP) is transmitted within parameters 540 to the call center. The call center in accordance with the invention, retrieves the identifying parameter and determines which other call center is closest to the caller or the originating switch. The call center then forwards, either via an SS7 or a VoIP network, the call to that closest call center.

The choice of parameter included in the IAM is typically set up beforehand between the information assistance service operating the call centers and the carrier operating the switches. A CGLIP (caller geodetic location information parameter) is most accurate to identify the current location of the caller's phone. This parameter may be realized using the technology in accordance with the federal mandate of the Enhanced 911 (E-911) initiative or GPS (global positioning system) technology. This information is typically available in WGS 84 format (World Geodetic System 1984). WGS 84 is an earth-fixed global reference frame, which includes an earth model. (More information on WGS 84 can be found at http://www.wgs84.com). Location information in WGS 84 format can be converted to latitude and longitude.

A JIP (jurisdiction information parameter) may be used to identify the originating switch location. It is typically found in the form “NPA-NXX,” where “NPA” is the area code of the switch and “NXX” is the exchange of the switch. The NPA-NXX information is used to look up in a LERG (local exchange routing guide) the switch ID, an 11-character identification code (also called a “CLLI” code, described below). (LERG is a trademark of Telcordia Technologies, Inc.) The LERG is an industry-standard guide supplied by Telcordia Technologies, Inc. (formerly Bellcore) that includes tables and databases relating, among other things, area codes, telephone exchanges, states, LATAs, switch IDs and locations, and coordinates. Another table in the LERG is then used to convert the switch ID to vertical and horizontal coordinates (in the V and H Coordinate System, developed by AT&T in the 1950s) of the switch. These V and H coordinates can then be converted to latitude and longitude by using, e.g., a software program called VHCALC distributed by Telcordia Routing Administration (TRA). This use of the LERG to convert the JIP to latitude and longitude is just one example of how such a conversion may be accomplished. There may be other databases or tools that convert the parameter to longitude and latitude in more or fewer steps.

A CRP (call reference parameter) may also be used to identify the originating switch location. This parameter contains point code information for the originating switch. The point code information is used in a point code database (supplied by Telcordia) to find the switch ID, which, as with the JIP, can be used to look up in the LERG to find the V and H coordinates. As with the JIP, these coordinates can be converted to latitude and longitude.

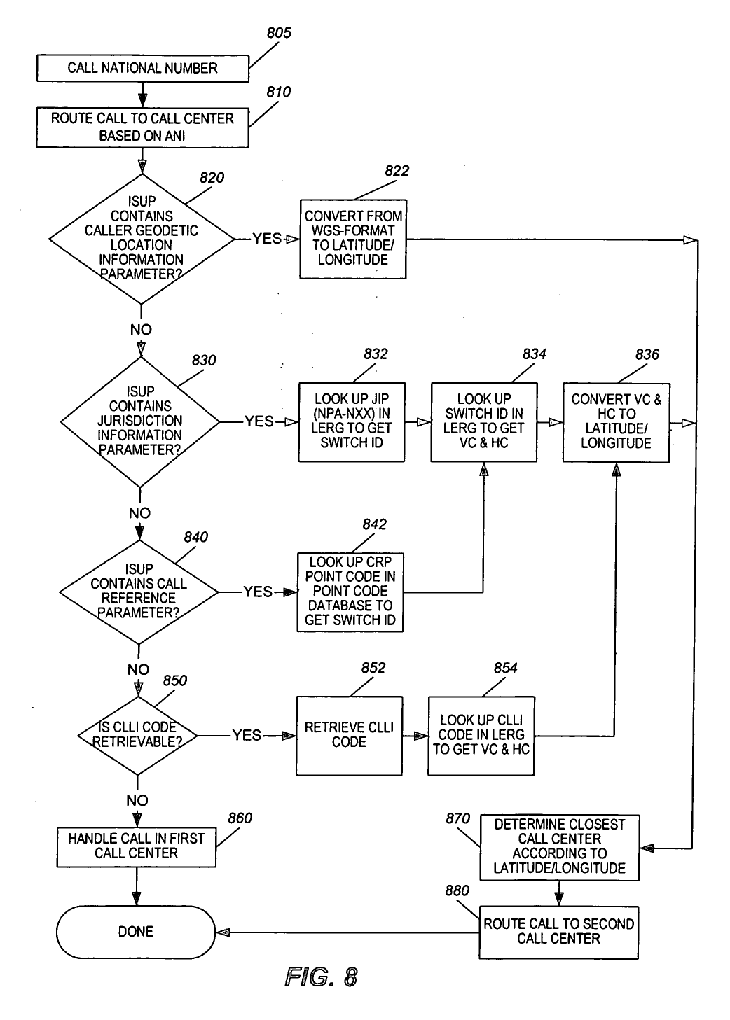

If none of these parameters is available to the call center to determine the location of the originating switch, there is a fourth method, but this requires additional steps. This involves destination switch 410b sending a CVT (circuit validation test) ISUP message (shown in FIG. 7A) back to originating switch 410a. In response, originating switch 410a sends a CVR (circuit validation response) ISUP message (shown in FIG. 7B), which may include the originating switch's “CLLI” code (CLLI is a trademark of Telcordia Technologies, Inc.), which stands for Common Language® Location Identification.

The CLLI code is a unique eleven-character (sometimes eight-character) alphanumeric descriptor used to identify switches, telephone plant items, buildings, equipment sites, points of interconnection, and other categories of telephony network elements and their. locations. CLLI codes are stored in a national database maintained by Telcordia. The assignment of a CLLI code is a prerequisite to the assignment of a 3-digit exchange (“NXX”) for switches. CLLI codes are also stored in the LERG. The code structure is: AAAABBCCDDD, where:
AAAA is the geographical or place code (e.g., city)
BB is the geopolitical or state/country code
CC is the network site code
DDD is the network entity code
   The combination of these codes comprises a unique place, a unique building, and a specific entity. For example, CITYSTBDDS0 represents the first digital switch (DS0) in the town of CITY, in the state of ST, in the building BD.

Knowing the CLLI code (also called the “switch ID,” as discussed above), the call center, as with the JIP and CRP, uses the LERG to look up the V and H coordinates. As with the JIP and CRP, these coordinates can be converted to latitude and longitude.

FIG. 8 is a flowchart illustrating one way that an information assistance service call may be rerouted in order to better service a caller. In conventional step 805, a caller calls a national number, such as 1-800, 1-888, or 1-900. In step 810, the call is routed to a first call center based on the ANI. As described above and in FIG. 6, this involves originating switch 410a sending an 800-query message via STP 420a to an SCP, and the SCP returning the telephone number of the call center geographically closest to the location referenced by the ANI. Originating switch 410a then routes the call to the first call center, e.g., information/call center 101 in FIG. 2.

In accordance with the invention, the first call center examines the parameters in the ISUP message to determine the location of the caller or the originating switch. In step 820, it is determined whether the ISUP contains the CGLIP. If so, in step 822 the WGS format of the CGLIP is converted to latitude and longitude. Then, in step 870, the first call center determines the closest call center (the “second” call center) to the caller based on that latitude and longitude. In step 880, the first call center routes the call to the second call center, e.g., information/call center 105 in FIG. 2, using, e.g., SS7 forward transfer or VoIP.

If in step 820 the ISUP does not contain the CGLIP, in step 830 it is determined whether the ISUP contains the JIP of the originating switch. If so, in step 832, the first call center looks up the JIP (NPA-NXX) in the LERG to derive the switch ID, in step 834 it looks up the switch ID to determine the V and H coordinates, and in step 836 it converts the V and H coordinates to latitude and longitude. Then, as before, in steps 870 and 880, the first call center determines the identity of the call center closest to the originating switch and transfers the call to that second call center.

If in step 830 the ISUP does not contain the JIP, in step 840 it is determined whether the ISUP contains the CRP of the originating switch. If so, in step 842, the first call center looks up the CRP point code in the point code database to find the switch ID of the originating switch. Then, as with JIP, in step 834 the call center looks up the switch ID in the LERG to determine the V and H coordinates, in step 836, the call center converts the V and H coordinates to latitude and longitude, and, in steps 870 and 880, the call center determines the identity of the call center closest to the originating switch and transfers the call to that second call center.

If in step 840 the ISUP does not contain the CRP, in step 850 it is determined whether the CLLI code is retrievable. If so, in step 852, the first call center retrieves the CLLI code. As described above, this requires the first call center to send a CVT ISUP message to originating switch 410a. Originating switch 410a responds with a CVR ISUP message containing its CLLI code. (This CVT-CVR sequence typically takes less than 1 second.) In step 854, the first call center looks up the CLLI code (or switch ID) in the LERG to find the V and H coordinates. Then, as with CRP and JIP, in step 836, the call center converts the V and H coordinates to latitude and longitude. Then, again, in steps 870 and 880, the first call center determines the identity of the call center closest to the originating switch and transfers the call to that second call center.

If in step 850 the CLLI code is not retrievable, in step 860 the call is handled in the first call center.

Note that the order of inquiry of these parameters in FIG. 8—CGLIP, JIP, CRP, CLLI code—is not critical, although it is preferable for the CLLI code to be the last inquiry made because it requires additional steps. As was mentioned before, the CGLIP identifies the caller's location and the JIP, CRP, and CLLI code identify the location of originating switch 410a, which is at most within 50-100 miles of the caller, and most often much less. The choice of which parameter is available is usually determined a priori between the network carrier and the information assistance provider. In addition, the advent of E-911 may dictate the use of CGLIP.

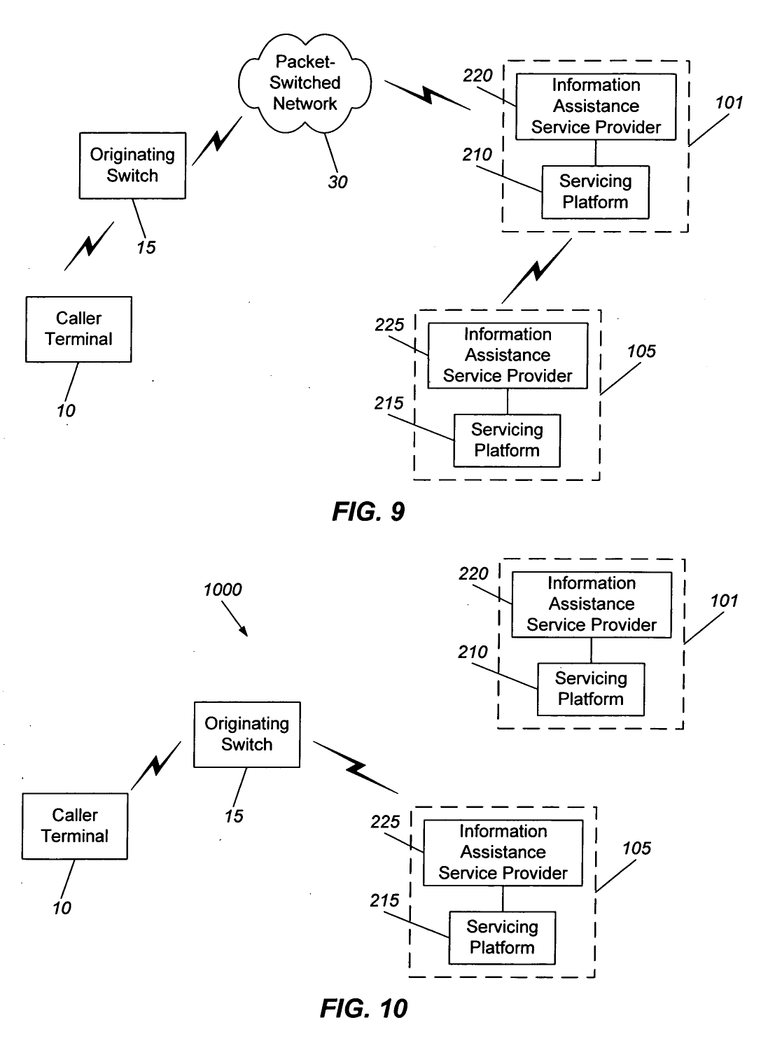

Additional advantages and modifications of the invention will readily occur to those skilled in the art. For example, the voice content of a call may be formatted according to a VoIP protocol, and establishment and termination of the VoIP call is performed via SIP signaling which may contain a call identifier and a caller location or an originating switch identifier. One way of transmitting a VoIP call is shown in FIG. 9, in which the call is routed from caller terminal 10 to originating switch 15, where the call is converted to packets. From there, the call is sent to packet-switched network 30, e.g., the Internet, and then sent to information/call center 101. Information/call center 101 may contain a VoIP interface card or voice data access card (VDAC) to receive the call. Then, information/call center 101 receives the caller location (e.g., CGLIP) or the originating switch identifier (e.g., JIP, CRP, or CLLI code), determines the location of the caller or the originating switch, and determines that information/call center 105 is geographically closest to the caller or the originating switch. Information/call center 101 then reroutes the call over a VoIP network to information/call center 105.

The invention may also be used to provide information assistance to land-based telephones having area codes that are not related to the geographic location of the telephone itself, such as with cable telephony or IP telephony providers who allow their customers to choose any U.S. telephone area code. In this case, the area code is not indicative of the caller's actual location. However, the originating switch identifier found in the signaling stream allows the call center receiving the call based on the ANI to reroute the call to a call center geographically closer to the caller.

A variation of the embodiment outlined in FIGS. 2 and 8 involves routing the call to the closest call center, not by the first call center, but by the originating switch or by some other intermediate switch. This scenario is illustrated in system 1000 in FIG. 10. The basis for this technique is that the originating switch knows its location already, so it routes the call to the closest call center to itself. In this scenario, as before, the caller calls the national number of the information assistance service, but the call is not routed to the first call center based on ANI. In fact, the ANI is not required in this embodiment. In addition, none of the other location parameters, e.g., CGLIP, JIP, CRP, or CLLI code, is required (but they may still be included in the ISUP message). As before, originating switch 410a sends via STP 420a to an SCP an 800-query message containing the called number (i.e., DNIS), and the SCP returns a list of call center telephone numbers associated with the national number. In this variation of the invention, originating switch 410a (using, e.g., a processor), knowing its own location, then determines which of those call centers is geographically closest to itself and routes the call to that closest call center, e.g., information/call center 105 in FIG. 10, bypassing information/call center 101. This variation can operate in a VoIP network (where the call is routed from packet-switched network 30 to information/call center 105, bypassing information/call center 101) or with the land-based telephones serviced by cable telephony and IP telephony providers, as previously described.

Up to this point, the choice of a call center to service the call has been based upon geographic proximity to the caller or the originating switch. However, there may be other considerations or criteria that may result in routing a call to a call center that is not the closest to the caller or originating switch. For instance, the call may be routed to a different call center based on expected wait time. Thus, the first choice for a call center may be the one closest to the caller, but if that call center is busy, or if the expected wait time at that closest call center is unacceptable, the next closest call center may be chosen, again, if the expected wait time at that next closest call center is not unacceptable. Other criteria for choosing a call center not based on ANI may include whether a call center is within or near the same state, LATA, or time zone as the caller or originating switch. Other geographic classifications for choosing a call center not based on ANI may be readily determined by one of ordinary skill in the art.

Finally, information/call centers 101 and 105 (and the other information/call centers) are disclosed herein in a form in which various functions are performed by discrete functional blocks. However, any one or more of these functions could equally well be embodied in an arrangement in which the functions of any one or more of those blocks or, indeed, all of the functions thereof are realized, for example, by one or more appropriately programmed processors.

The present invention in its broader aspects is not limited to the specific embodiments, details, and representative devices shown and described herein. Accordingly, various changes, substitutions, and alterations may be made to such embodiments without departing from the spirit or scope of the general inventive concept as defined by the appended claims.

1. A method for routing a call from a communications device to a call center, comprising:
receiving the call at a first call center, the call being routed to the first call center based on a communications device identifier;
determining the geographic vicinity of the communications device; and
routing the call to a second call center if that second call center is closer to the geographic vicinity of the communications device than the first call center.

2. The method according to claim 1, wherein the communications device identifier is automatic number identification (ANI).

3. The method according to claim 1, further comprising receiving a signaling stream associated with the call, the signaling stream including at least a caller location identifier or an initiating switch locator for respectively identifying the geographic vicinity of the caller or a switch through which the call is initially being routed.

4. The method according to claim 3, wherein the geographic vicinity of the communications device is determined by decoding the caller location identifier or the initiating switch locator.

5. The method according to claim 4, wherein the caller location identifier comprises a caller geodetic location information parameter (CGLIP).

6. The method according to claim 5, wherein the decoding comprises converting the CGLIP from WGS format to latitude and longitude.

7. The method according to claim 4, wherein the initiating switch locator comprises a jurisdiction information parameter (JIP).

8. The method according to claim 7, wherein the decoding comprises:
converting the JIP to a switch ID;
converting the switch ID to geographical coordinates; and
converting the geographical coordinates to latitude and longitude.

9. The method according to claim 4, wherein the initiating switch locator comprises a call reference parameter (CRP).

10. The method according to claim 9, wherein the decoding comprises:
converting the CRP to a switch ID;
converting the switch ID to geographical coordinates; and
converting the geographical coordinates to latitude and longitude.

11. The method according to claim 4, wherein the initiating switch locator comprises a common language location identification (CLLI) code.

12. The method according to claim 11, wherein the decoding comprises:
converting the CLLI code to geographical coordinates; and
converting the geographical coordinates to latitude and longitude.

13. The method according to claim 3, wherein the signaling stream is formatted in accordance with an SS7 protocol.

14. The method according to claim 3, wherein the content of the call is formatted according to a VoIP protocol and the signaling stream is formatted according to a session initiation protocol.

15. The method according to claim 3, wherein the content of the call is formatted according to a VoIP protocol and the signaling stream is formatted according to an H.323 protocol.

16. The method according to claim 1, wherein the second call center is within the same state as that of the communications device.

17. The method according to claim 1, wherein the second call center is within the same LATA as that of the communications device.

18. The method according to claim 1, wherein the second call center is within the same time zone as that of the communications device.

19. The method according to claim 1, wherein there is a plurality of call centers closer to the geographic vicinity of the communications device than the first call center, and the second call center is the one call center out of the plurality of call centers that is closest to the geographic vicinity of the communications device.

20. The method according to claim 19, further comprising routing the call to a third call center based on the expected wait time at the second call center.

21. A system for routing a call from a communications device to a call center, comprising:
an interface for receiving at a first call center a signaling stream associated with the call, the signaling stream including at least a communications device identifier and a caller location identifier or an initiating switch locator, the caller location identifier identifying the geographic vicinity of the caller, and the initiating switch locator identifying the geographic vicinity of the switch through which the call is initially being routed;
a database for relating the caller location identifier or initiating switch locator to the geographic vicinity of the caller or initiating switch, respectively; and
a processor for retrieving the geographic vicinity of the caller or initiating switch, for determining a second call center closer to the geographic vicinity of the caller location or initiating switch location, and for routing the call to that second call center.

22. The system according to claim 21, wherein the communications device identifier is automatic number identification (ANI).

23. The system according to claim 21, wherein the caller location identifier comprises a caller geodetic location information parameter (CGLIP).

24. The system according to claim 23, wherein the processor decodes the caller location identifier by converting the CGLIP from WGS format to latitude and longitude.

25. The system according to claim 21, wherein the initiating switch locator comprises a jurisdiction information parameter (JIP).

26. The system according to claim 25, wherein the processor decodes the initiating switch locator by:
converting the JIP to a switch ID;
converting the switch ID to geographical coordinates; and
converting the geographical coordinates to latitude and longitude.

27. The system according to claim 21, wherein the originating switch identifier comprises a call reference parameter (CRP).

28. The system according to claim 27, wherein the processor decodes the initiating switch locator by:
converting the CRP to a switch ID;
converting the switch ID to geographical coordinates; and
converting the geographical coordinates to latitude and longitude.

29. The system according to claim 21, wherein the initiating switch locator comprises a common language location identification (CLLI) code.

30. The system according to claim 29, wherein the processor decodes the initiating switch locator by:
converting the CLLI code to geographical coordinates; and
converting the geographical coordinates to latitude and longitude.

31. The system according to claim 21, wherein the signaling stream is formatted in accordance with an SS7 protocol.

32. The system according to claim 21, wherein the content of the call is formatted according to a VoIP protocol and the signaling stream is formatted according to a session initiation protocol.

33. The system according to claim 21, wherein the content of the call is formatted according to a VoIP protocol and the signaling stream is formatted according to an H.323 protocol.

34. The system according to claim 21, wherein the second call center is within the same state as that of the communications device.

35. The system according to claim 21, wherein the second call center is within the same LATA as that of the communications device.

36. The system according to claim 21, wherein the second call center is within the same time zone as that of the communications device.

37. The system according to claim 21, wherein there is a plurality of call centers closer to the geographic vicinity of the communications device than the first call center, and the second call center is the one call center out of the plurality of call centers that is closest to the geographic vicinity of the caller location or initiating switch location.

38. The system according to claim 37, wherein the call is routed to a third call center based on the expected wait time at the second call center.
